(19) United States
(12) Patent Application Publication
(10) Pub. No.: US 2012/0149601 A1
(43) Pub. Date: Jun. 14, 2012

(54) Methods and systems for detection of nitroalkyl, nitroamine, nitroaromatic and peroxide compounds

(76) Inventors: Michael J. Knapp, Belchertown, MA (US); Meaghan Germain, Northampton, MA (US)

(21) Appl. No.: 12/077,785

(22) Filed: Mar. 21, 2008

Related U.S. Application Data
(60) Provisional application No. 60/919,283, filed on Mar. 21, 2007.
(60) Provisional application No. 61/003,667, filed on Nov. 19, 2007.

(51) Int. Cl. G01N 21/64; C40B 40/16

(52) U.S. Cl. 506/21; 436/172; 422/82.08; 436/135; 436/106

(57) ABSTRACT

Methods, systems and related apparatus for fluorescence-based detection of various nitro and peroxide compounds.

This application claims priority benefit from prior application Ser. Nos. 60/919,283 and 61/003,667, filed Mar. 21, 2007 and Nov. 19, 2007, respectively, each of which is incorporated herein by reference in its entirety.

### BACKGROUND OF THE INVENTION

Chemical explosives detection is of much current interest for both defense, security, environmental cleanup and for humanitarian purposes such as clearing unexploded landmines. Chemical explosives frequently contain easily reduced compounds such as nitroalkanes, nitroaromatics, nitroamines, or peroxides. Their detection can be challenging in general, with limited examples of optical-based detection methods. Further challenges are presented when faced with discrimination of the various chemical explosives from other compounds, and methods which combine optical detection with multi-component analysis would permit such discrimination.

Chemical explosives based upon trinitrotoluene also contain byproducts such as dinitrotoluene (DNT), making nitroaromatics important targets for explosives detection. While DNT has a moderate vapor pressure which may permit detection by canine teams, fluorescence-based detection methods are being developed to improve reliability. Examples of fluorescence-based sensors for DNT include conjugated polymers based on phenyleneethynylene, polyacetylene and metalloles, as nitroaromatics both bind tightly to these aromatic groups and quench the fluorescence of these easily oxidized fluorophores due to an electron transfer process. Many plastic explosives do not contain nitroaromatics, however, making detection problematic for these compounds. Consequently, all commercially available plastic explosives are required by law to contain a high-vapor pressure taggant, such as 2,3-dimethyl-2,3-dinitrobutane (DMNB), to facilitate detection by canine teams. Unfortunately, DMNB is difficult to detect by fluorescence quenching due to its low reduction potential.

There is one report in which phenyleneethynylenes or polyphenylenes modified by π-donors exhibited moderately efficient quenching by DMNB. However, such polymers become non-fluorescent in certain use applications. Likewise, notwithstanding the reported quenching by DMNB, they generally exhibit poor sensitivity to nitroalkanes. With limited potential for structural modification, such polymers have, likewise, limited tunability with respect to detection sensitivity and/or wavelength of fluorescence emission.

Similar issues hinder detection of peroxide or nitroamines. Most current methods exhibit low sensitivity. As a result, it has been an on-going concern in the art to develop additional chemical systems and structures for sensing nitroaromatics and DMNB. While nitroamines are examples of organic nitro compounds, their detection presents a unique challenge, and a comprehensive approach for detection of other explosive materials, such as organic peroxides and nitroamines, is highly desirable.

### SUMMARY OF THE INVENTION

In light of the foregoing, it is an object of the present invention to provide one or more detection methods and/or systems, thereby overcoming various deficiencies and shortcomings of the prior art, including those outlined above. It will be understood by those skilled the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of the present invention to provide a fluorescence-based method and class of fluorophores useful in conjunction therewith, exhibiting good sensitivity over a range of nitro and peroxide compounds, including those used as chemical taggants for plastic explosives.

It can be another object of the present invention to provide one or more fluorophore compounds which can be structurally modified to affect fluorescence emission and the sensitivity to one or more such nitro and peroxide compounds.

It can also be an object of this invention, alone or in conjunction with any of the preceding objectives, to provide such a method and/or sensor apparatus operable over a range of use conditions or environments.

Other objects, features, benefits and advantages of the present invention will be apparent from this summary and the following descriptions of certain embodiments, and will be readily apparent to those skilled in the art having knowledge of various fluorescence-based detection methods. Such objects, features, benefits and advantages will be apparent from the above as taken into conjunction with the accompanying examples, data, figures and all reasonable inferences to be drawn therefrom.

In part, the present invention can be directed to a method of detecting the presence of a compound selected from nitro and peroxide analyte compounds. Such a method can comprise providing a system comprising a Zn metal center and salen or schiff-base ligand; providing an analyte component comprising a compound; irradiating the system with near-ultraviolet light; contacting such a system and such a component/analyte; and determining and/or monitoring change in fluorescence of the system to detect the presence of such an analyte, any such change as can be indicative of the presence of at least one analyte compound. In certain embodiments, the Zn metal center can be associated with and/or coordinated to a salophen ligand, the phenyl moieties thereof as can be structurally varied and/or substituted as would be known to those skilled in the art. Such a system can comprise monomers, dimers and/or mixtures of one or more such complexes optionally in the presence of various other metal centers, ligands and/or related complexes. In certain other embodiments, such a system can comprise a plurality of Zn(salen) complexes, each such complex providing a change in fluorescence responsive to the presence of an analyte. Such interaction can provide a quenching pattern indicative of the presence of a particular nitro or peroxide analyte. Regardless, such a system can comprise such a Zn complex and/or mixtures thereof in a solid state or as can otherwise be provided in the context of a solid support, substrate or matrix, or in solution or as can otherwise be provided in the context of a fluid medium. In certain such embodiments, such a system can also comprise a solvent component. Such components can include but are not limited to ethanol, tetrahydrofuran, pyridine, dimethylsulfoxide, acetonitrile and combinations thereof.

In certain embodiments, the component of such a system can comprise a substrate or article of manufacture comprising such a Zn complex or compound. Regardless of the identity of any particular Zn complex, a compound contacted with such a system can have a reduction potential associated with the oxidation potential of such a complex, to at least partially affect the time and/or intensity of complex fluorescence upon irradiation. In certain such non-limiting embodiments, as discussed elsewhere herein, such an analyte compound can be a taggant or otherwise present in conjunction with an explosive material. Without limitation, such compounds can comprise a range of organic nitro compounds, such as nitroaromatics, including but not limited to trinitro- and dinitrotoluene and nitroalkanes, including but not limited to 2,3-dimethyl-2,3-dinitrobutane and organic peroxide compounds, including but not limited to triacetone triperoxide (TATP); and organic nitroamine compounds, including but not limited to cycloteteramethylene-tetranitramine (HMX), and cyclotrimethylenetrinitramine (RDX).

In part, the present invention can also be directed to a method of using Zn(salen) fluorescence to detect a nitro and/or peroxide analyte compound. Such a method can comprise providing a Zn(salen) complex; irradiating such a complex for a time and/or at a wavelength at least partially sufficient for fluorescence; contacting the complex with an analyte compound comprising nitro and/or peroxide groups, such contact and/or compound concentration at least partially sufficient to affect and/or change fluorescence; and monitoring change in fluorescence upon such contact. The Zn(salen) complexes employed with such a method can comprise those discussed above or as illustrated elsewhere herein, alone or in combination with one or more other complexes as can be present. Regardless, such a complex can be irradiated at a wavelength at least partially sufficient for electronic excitement and/or fluorescence thereof. Likewise, as discussed above and illustrated elsewhere herein, contact with such an analyte can be for a time and/or at a concentration at least partially sufficient for electron transfer and/or to affect complex fluorescence. Such a compound, whether organic or non-organic, can be present in the context of an explosive material or another such substrate, the identity of which is limited only by its reduction potential in the context of a corresponding oxidation potential of an electronically-excited Zn(salen) complex. In certain embodiments, such a compound can be observed to quench such a fluorescent excited state, as can be indicated by a change in visible wavelength fluorescence.

As discussed above, a Zn complex of such a system or as used in the context of such a method, can be present in a solid state or in a fluid medium. As demonstrated below, properties of a fluorescent excited state, together with wavelength of fluorescence emission, can be modified by choice of salen or schiff-base ligand and/or substituent(s) thereon. Choice of ligand/substituents can be used to design the sensitivity of any particular Zn(salen) complex to one or more analyte compounds. With regard to the former, variation in ligand/substituent(s) structure can also be used to tune and/or affect emission color, fluorescence intensity, excited state redox potential, fluorescence quantum yield and—in effect—provide discriminant sensing capability.

Accordingly, the present invention can also be directed to a method of detecting the presence of and/or identifying an explosive-related nitro or peroxide compound. Such a method can comprise providing reference spectral data comprising change in fluorescence for interaction of a Zn(salen or schiff-base) complex with a plurality of reference compounds selected from peroxide and nitro compounds and combinations thereof; comparing such reference data with change in fluorescence for interaction or contact of such a complex with a subject analyte; and identifying the subject analyte and/or a compound thereof indicated by or on the basis of such a comparison. In certain embodiments, such reference data can comprise fluorescence changes from interaction of a plurality of such complexes with the reference compounds. As described above, such complexes can be varied by ligand and/or substitution thereon. Without limitation as to number of complexes employed in comprising the reference data, subject analyte identification can be made by direct spectral comparison. Use of a plurality of Zn complexes can provide fluorescence change(s) or quenching pattern(s) indicative of the presence of one or more particular analytes. Alternatively, comparison can be made using one or more discriminant analysis techniques, as described below.

Alone, or in conjunction with discriminant analysis, the present invention can also be directed to an apparatus for detection of a nitro or peroxide explosive and/or taggant material. Without limitation as to physical embodiment or configuration, such a sensor apparatus can comprise a spectrophotometer and a solid substrate and/or matrix comprising one or an array of a plurality of Zn complexes, of the sort described herein, positioned thereon, coupled thereto and/or incorporated therewith. As illustrated below, such complexes can be chosen to provide differential changes in fluorescence, each responsive to a range of peroxide and nitro analyte compounds. Fluorescence change upon analyte interaction and comparison with reference spectral data, as described above, can be used for discriminant analyte identification when such an apparatus comprises or is coupled to appropriate processor. As discussed above and illustrated elsewhere herein, such complexes are not quenched by incorporation with a solid substrate, permitting a range of immobilization strategies including the use of polymeric matrices in the fabrication of such a sensor array apparatus.

### BRIEF DESCRIPTION OF THE DRAWINGS

FIG. 1. ORTEP of ZnL(EtOH).EtOH. H-atoms omitted for clarity.

FIG. 2. Hydrogen bonding array in ZnL(EtOH).EtOH. Select bond lengths (Å) and bond angles: O₄₁—H₄₁, 0.79(3); O₄₁—O₄₄, 2.679; O₄₄—O₄₁, 2.963; O₄₄—H₄₄, 0.82; O₄₁—H₄₁—O₄₄, 170°; O₄₄—H₄₄—O₄₁, 150°.

FIG. 3. Ligand contacts and π-stacking within the lattice of ZnL(base). A) pyridine. B) ethanol. C) tetrahydrofuran.

FIG. 4. ¹H-NMR of ZnL(EtOH).EtOH in CD₂Cl₂.

FIG. 5. ¹H-NMR titration of ZnL(EtOH).EtOH (12 mM) in CD₂Cl₂. Total EtOH concentrations from bottom to top: 25 mM, 71 mM, 146 mM, 370 mM. Peaks labeled as in FIG. 4.

FIG. 6. Ethanol titration of ZnL (12 mM) in dichloromethane (400 MHz NMR).

FIG. 7. Electronic absorption (solid line), emission (dotted line), and excitation (dashed line) spectra of ZnL(EtOH).EtOH in dichloromethane solution.

FIG. 8. Emission spectra of ZnL(base) microcrystalline solids (dashed=py, solid=EtOH, dotted=THF).

FIG. 9A. Quenching of ZnL (4.3 μM) fluorescence by NT (▪) or DMNB (⋄) in acetonitrile.

FIG. 9B. Stern-Volmer Plot for 4.3 μM ZnL with Q in Acetonitrile λₑₘ=535 nm ⋄Q=DMNB, K_{SV}=2.1; ▴Q=Nitro-m-Xylene, K_{SV}=3.5; ▪Q=Nitrotoluene, K_{SV}=5.3; a ◯Q=Nitrobenzene K_{SV}=6.9, [symbol] Q=Nitroquinoline, K_{SV}=49.

FIG. 10. Quenching efficiency (K_{SV}) for each nitro compound with ZnL vs. observed reduction potentials in acetonitrile.

FIGS. 11A-B. Zn(3,5-di-t-butyl salicylaldimine) and Zn(5-t-butyl salicylaldimine) Fluorescence Quenching by benzoyl peroxide, in accordance with certain embodiments of this invention; e.g., detection of peroxide explosives including but not limited to TATP.

FIG. 12. Fingerprints for the 9 nitro-containing quenchers in a representative 7-ZnL^{R} array. Percent quenching calculated from ((Iₒ−I)/I₀)×100, where I₀ is the fluorescence intensity of ZnL^{R}. Quencher samples normalized, A₃₀₀=1.

FIG. 13. Canonical scores (99%) plot for 9 quenchers with 5 unknown samples. Quencher samples normalized, A₃₀₀=1. Samples are assigned by the shortest Mahalanobis distance to each centroid. All five unknowns categorized correctly, (Unknown 1=DNB, Unknown 2=ClNB, Unknown 3=ClAmp, Unknown 4=NB, Unknown 5=NT), demonstrating a sensor array and related embodiments of this invention.

### DETAILED DESCRIPTION OF CERTAIN EMBODIMENTS

Salen and related schiff-base complexes of zinc are fluorescent by irradiation with near ultraviolet light, emitting visible-wavelength fluorescence. Electron poor molecules such as the nitro and/or peroxide compounds associated with various explosive materials, can affect and/or otherwise quench the fluorescence. Such an effect can be observed or detected whether such a Zn complex is present in solution or a solid state, regardless of whether an nitro and/or peroxide compound, whether organic or non-organic, is in a liquid, vapor and/or solid phase and/or present in or with an explosive material.

For purposes of the present methods and/or systems, the following expressions and terms, unless otherwise indicated, can be understood as having the meaning ascribed thereto by those skilled in the art or as otherwise indicated with respect thereto:

“Organic nitro compound” means a compound comprising one or more nitro groups alone or present with one or more other groups or moieties, including but not limited to one or more amino groups, any such groups or combinations thereof present in an alkyl, cyclic alkyl, alkenyl or cyclic alkenyl (including aromatic, e.g., phenyl, etc.) compound structure including such heteroatom-substituted structures; and

“Organic peroxide compound” means a compound comprising one or more peroxide groups alone or present with one or more other groups or moieties, any such groups or combinations thereof present in an alkyl, cyclic alkyl, alkenyl or cyclic alkenyl (including aromatic, e.g., phenyl, etc.) compound structure including such heteroatom-substituted structures.

Certain non-limiting embodiments of this invention and the fluorescence properties of the present Zn complexes can be considered through the relationship between structure and emission wavelength for ZnL (e.g., Scheme 1, H₂L=N,N′-phenylenebis-(3,5-di-tert-butylsalicylideneimine), as well as the fluorescence quenching of this structure by nitroaromatics and DMNB. Representative of other such compounds/complexes used with this invention, ZnL undergoes moderately efficient fluorescence quenching in the solution phase by electron transfer with nitroaromatics and DMNB. (As indicated, above, the term “salen” indicates the generic class of salicylaldimine ligands formed by the Schiff base condensation of salicylaldehyde with a di-amine such as but not limited to 1,2-ethylenediamine. Salophen refers to a subset in which ortho-phenylenediamine is used as the di-amine.) While H₂L is a tetradentate ligand, the strong preference of Zn(II) for pentacoordination is evident from the observation that solid-state structures of (salen)Zn complexes are pentacoordinate, either due to the addition of a monodentate ligand, which is possible when the salicylaldehyde substituents R₁ and R₂ are large, or by formation of phenol-bridged dimers, when these substituents are small. Solution NMR and molecular weight determinations are reported herein to establish a similar speciation between monomeric and dimeric structures (Scheme 1). The fluorescence properties of ZnL are not changed significantly by the monomer-dimer equilibrium, nor by the binding of a variety of Lewis bases to form monomeric ZnL(base). In contrast, X-ray crystallographically determined structures of three forms of ZnL(base) reveal that solid-state packing changes significantly with different Lewis bases, which leads to a large shift in the solid state emission wavelength.

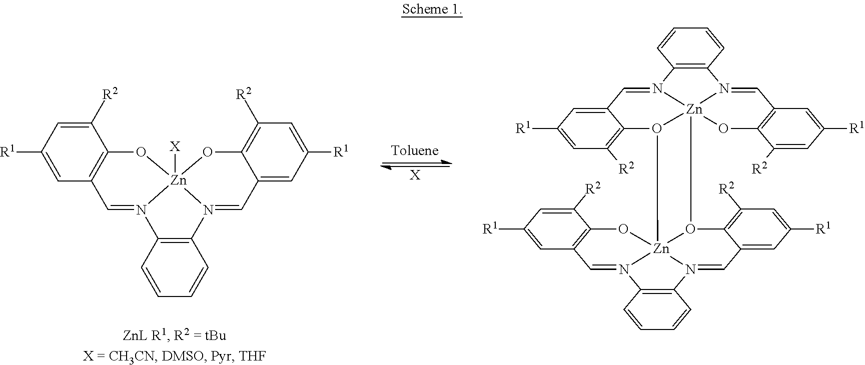

Description of Structures. Crystals suitable for X-ray diffraction were obtained by recrystallizing ZnL from the respective solvents, and the structures determined at ˜125K. The structures of ZnL(base), base=THF, py, were previously determined at room temperature and reported; however, those coordinates are not available through Cambridge Structural Database. (Singer, A. L.; Atwood, D. A. Inorg. Chim. Acta 1998, 277, 157-162.) These data were collected in order to compare the intermolecular interactions in these solid lattices. As the metrical details for these two structures are available, only the relationship between intermolecular interactions of these complexes and emission wavelength will be discussed.

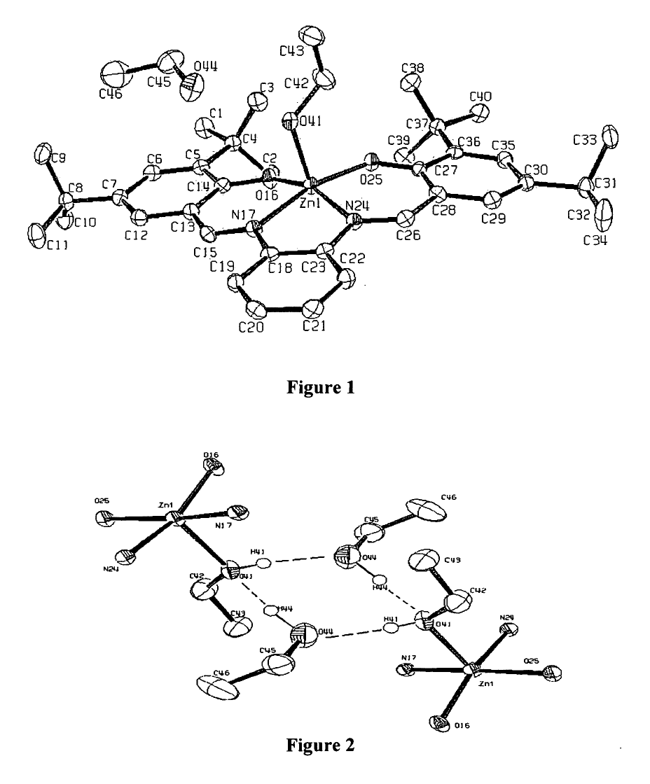

The molecular structure of ZnL(EtOH).EtOH revealed that the ethanol ligand to Zn(II) was hydrogen-bonded to the ethanol solvate (FIG. 1). Bond lengths for the ZnL moiety are in line with similar compounds, with Zn—O bonds of 1.9302(16) Å and 1.9586(16) Å, and Zn—N bonds of 2.0498(19) Å and 2.082(2) Å. The Zn(II) lies 0.291 Å above the plane defined by the N₂O₂ coordination shell of the salophen ligand, being distorted upward toward the axial ethanol. Similar distortions for base=THF (0.304 Å) and py (0.386 Å) are observed. The Zn-base bond-lengths for py, THF, and EtOH are 2.094 Å, 2.178 Å, and 2.161(2) Å, respectively.

Penta-coordinate Zn(II) can take a geometry ranging from square planar to trigonal bipyramidal. The geometry about Zn(II) was analyzed with the formalism in which internal angles are combined into a single parameter, τ, which ranges from 0 for square pyramidal to 1 for trigonal bipyramidal. ZnL(py) is perfectly square pyramidal, τ=0, while ZnL(EtOH) and ZnL(THF) are very nearly square pyramidal with τ=0.12, and τ=0.14 respectively. A survey of the Cambridge Crystallographic Database failed to reveal any other examples of square planar geometry in (salen)Zn complexes, however several other (salen)Zn complexes with 3,5-di-tertbutyl salicylidene groups exhibit τ in the range 0.16-0.33.

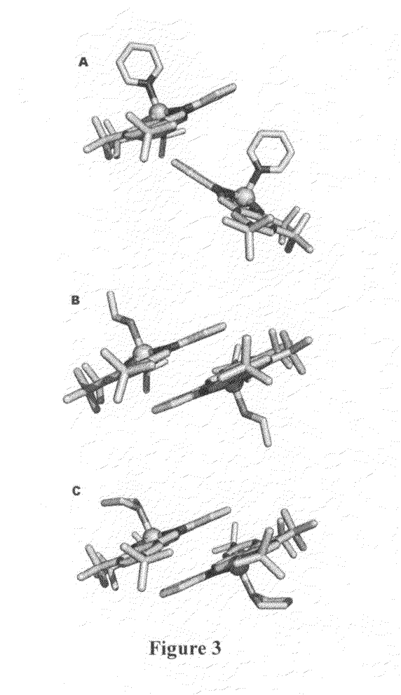

Inspection of the lattice for close contacts revealed the presence of a hydrogen-bonded array between the ethanols of two asymmetric units, forming a supramolecular dimer (FIG. 2). This hydrogen bonded array is planar and homodromic, in which the directionality of hydrogen bond donors follow a cyclic arrangement. The bond distances for hydrogen-bond donors and acceptors are 2.679 Å for O₄₁—O₄₄ (O₄₁ is the hydrogen bond donor) and 2.963 Å for O₄₄—O₄₁ that are typical for moderate strength hydrogen bonds. The X-ray structure was of sufficient quality to resolve the electron density of all hydrogens, with O₄₁—H₄₁ distances of 0.79(3) Å and O₄₄—H₄₄ distances of 0.82 Å observed. While one might anticipate that the O₄₁—H₄₁ bond should be lengthened from the combined effects of being a hydrogen bond donor and a ligand to the Lewis-acidic Zn(II), it has been noted that X-ray structures are biased due to the polarization of the electron density in hydrogen bonded pairs. Therefore, the inter-nuclear O—H distances are likely to be very close to the typical value of 0.9 Å for both O—H bonds.

There is one prior report in the art of a four-member hydrogen-bonded array involving ethanol coordinated to Zn(II) in interpenetrating (porphyrin)Zn complexes. The present crystal structure is of higher quality by virtue of the minimal disorder from the smaller salophen ligands, and thus gives better metrical details for the hydrogen bonding array. As the strength of typical hydrogen bonds between neutral molecules is relatively weak (−ΔH˜2-5 kcal/mol), the four member hydrogen bond array would stabilize the supramolecular dimer by less than 20 kcal/mol. The entropic cost of assembling the six molecules (4 EtOH and 2 ZnL) will likely exceed this enthalpic stabilization, however, and it is unlikely that such a dimer would form in solution. In fact, solution 1H-NMR in CD₂Cl₂ show the number of peaks anticipated for a C₂v symmetric ZnL, indicating that the dimer observed crystallographically is not present at detectable levels in solution (however, see the NMR data below).

The lattice packing for each of the three structures was inspected for intermolecular contacts. FIG. 3 shows that π-stacking is present for both ZnL(THF) and ZnL(EtOH), but entirely absent for ZnL(py). In the THF and EtOH complexes, the di-imine aryl ring of one ZnL stacks onto the imine groups of an adjacent ZnL, such that the angle between the N₂O₂ planes is 0°. The N₂O₂ planes are separated by 3.41 Å in ZnL(THF) and 3.44 Å in ZnL(EtOH), indicating close intermolecular contacts. On the other hand, the intermolecular interaction for ZnL(py) is predominantly between the di-imine aryl ring and the C—H protons of coordinated pyridine. The angle between the N₂O₂ planes is 47°, indicating the absence of it stacking.

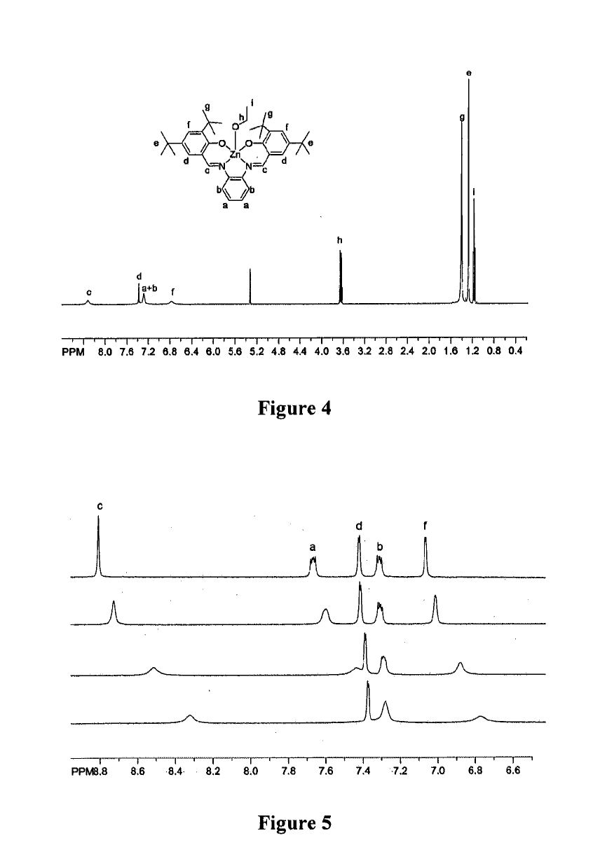

Ligand Binding and Speciation. The tendency of (salen)Zn complexes to crystallize as 5-coordinate molecular units is well known in the literature, with a phenolate-bridged dimer and a Lewis-base coordinated monomer the dominant structural motifs. Such crystal forms for ZnL arise from the binding of solvents that are good Lewis bases, consistent with the expectation that rapid ligand exchange for ZnL would lead to coordination of available bases. In the course of characterizing ZnL, it was noticed that the 1H-NMR spectra of ZnL(EtOH).EtOH in CD₂Cl₂ exhibited the number of peaks expected for ZnL with effective CS symmetry, indicating that the hydrogen-bonding network was lost (FIG. 4). However, the breadth of the 1H-NMR linewidths suggested that a chemical exchange process occurred in solution. If the solution chemical exchange process were due to a monomer-dimer equilibrium, then the molecular mass for ZnL would change between a good donor solvent and a poor donor solvent.

ZnL(EtOH).EtOH was dissolved in acetonitrile and toluene, and vapor pressure osmometry (VPO) was used to measure the solution molecular weight (MW_{obs}). As the VPO instrument was designed for use with aqueous solutions, solvents with vapor pressures comparable to water were needed; the high vapor pressure of CH₂Cl₂ precluded its use. The MW_{obs}, differed from 714 g/mol in acetonitrile to 1164 g/mol in toluene, compared with a true formula weight for ZnL of 602 g/mol and for ZnL(EtOH).EtOH of 696 g/mol. ZnL exists largely as a monomeric species in acetonitrile, consistent with the good donor properties of this solvent which likely leads to the formation of ZnL(CH₃CN), whereas a dimeric structure dominates in toluene.

The dimeric species could be bridged by either the hydrogen bonds of the ethanol molecules or through a phenolate. As ZnL(py) lacks opportunities for hydrogen bonding interactions and any dimeric species formed from this molecule would most likely be phenolate-bridged, ZnL(py) was also analyzed by VPO. The solution state molecular weight of ZnL(py) in toluene is 1195 g/mol, indicating that the dimeric structure of ZnL found in solution is likely bridged through phenolate bonding interactions. The broad NMR peaks in dichloromethane most likely reflect a dynamic monomer-dimer equilibrium.

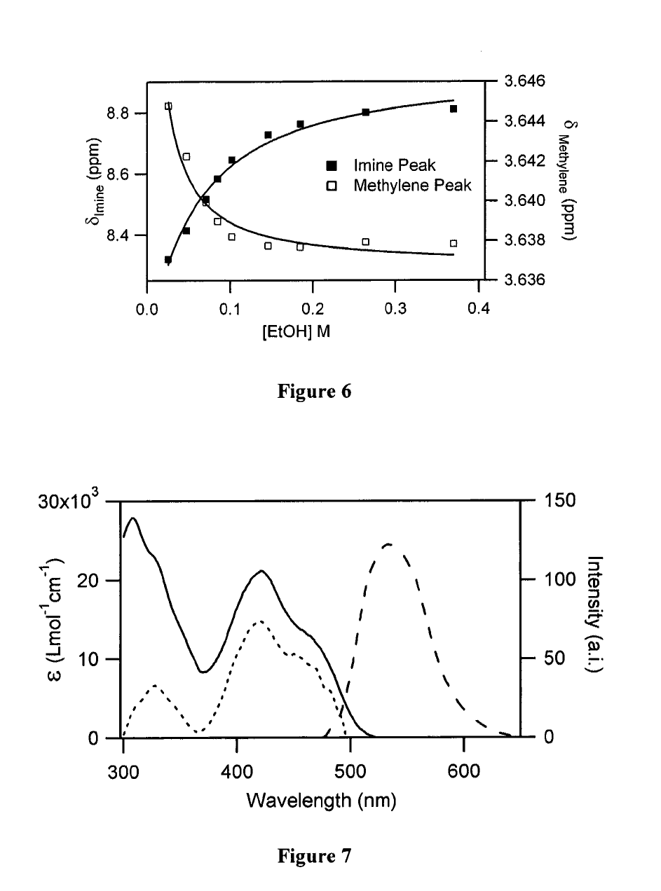

To push the equilibrium to favor the monomeric species, a dichloromethane solution of ethanol (2.2M) was titrated into a dichloromethane solution of ZnL(EtOH).EtOH (12 mM), and the chemical shift of the imine proton was used to monitor speciation. The imine peak is initially observed at 8.324 ppm in CD₂Cl₂ and shifts to a value of 8.809 ppm at 370 mM ethanol concentrations, as shown in FIG. 5. Additionally, the NMR peaks all narrow and sharpen at elevated ethanol concentrations, indicating that a single structure dominates under these conditions. The chemical shift of the imine peak was plotted as a function of total ethanol concentration and the resulting saturation curve, shown in FIG. 6, suggested a simple 1:1 binding model: ZnL(EtOH)⇄ZnL+EtOH.

This binding model leads to eq 1, below, in which δ_{obs} is the observed chemical shift, δi and δf are the initial and final chemical shift values, and K_{D} is the dissociation constant. The best fit curve resulted in the following parameters: δᵢ=8.012±0.09 ppm, δ_{f}=8.950±0.04 ppm, K_{D}=0.049±0.014 M. Likewise, the chemical shift of the methylene group of EtOH changed from 3.645 ppm to 3.638 ppm upon addition of 370 mM EtOH. The methylene binding curve was fit using eq. 1 to obtain δᵢ=3.661±0.009 ppm, δ_{f}=3.637±0.0005 ppm, and K_{D}=0.0089±0.006 M. This equilibrium constant is weaker than expected, as similar (salen)Zn complexes bind pyridines or methanol with an affinity of roughly 10⁻⁴ M. The apparent weakness of ethanol binding in this case may reflect the competitive nature of the equilibrium.

$${δ}_{obs} = \frac{{δ}_{f} - {δ}_{i}}{2 [ Et OH ]} \{ \begin{matrix}( [ Et OH ] + [ Zn L ] + {K}_{D} ) - \\ \sqrt{{( [ Et OH ] + [ Zn L ] + {K}_{D} )}^{2} - 4 [ Et OH ] [ Zn L ]}\end{matrix} \} + {δ}_{i} \qquad ( 1 )$$

The NMR titration and the solution molecular weight determination indicate that ZnL equilibrates between a monomeric and dimeric species in solution. The position of the equilibrium depends upon the availability of Lewis bases which can coordinate to ZnL, which in concert with the reported crystal structures indicates that good donor solvents are likely to form a ZnL(solvent) monomeric species. In dichloromethane, addition of ethanol pushed the equilibrium to favor the monomeric ZnL species. This monomer-dimer equilibrium was seen to also depend upon the bulk solvent, as a monomeric species was favored in the good donor solvent acetonitrile, whereas a dimeric structure was favored in toluene. This tendency of (salen)Zn to acquire an axial ligand has been used in supramolecular chemistry, such as in the energy transfer work of Hupp and Nguyen, and the recent report of a bifunctional hydroformylation catalyst from the Reek group.

Excited-state redox potential. A small number of reports indicated that (salen)Zn complexes exhibit fluorescence as both solids and solutions. It was demonstrated that energy transfer was efficient for (salen)Zn; however, visible absorption was lacking for many analytes, including nitroaromatics. Accordingly, the excited-state redox properties of ZnL were estimated to determine its suitability for electron-transfer reactivity with nitro-containing molecules.

Absorption, excitation, and emission spectra of ZnL were measured in dichloromethane (FIG. 7). The peak absorption at 424 nm (λₘₐₓ) exhibited a low-energy shoulder at ˜450 nm. The emission maximum is 538 nm, with an excitation maximum of 424 nm. These are consistent with prior reports for salen-type ligands with aromatic diamines, in which the fluorescent excited state was described as dominantly singlet in character.

To test for the effects of coordinated base, ZnL(EtOH).EtOH was dissolved in common solvents then filtered to ensure removal of any solids. The solvents ethanol, pyridine, and THF were shown to coordinate to ZnL to form the ZnL(solvent) complex by crystallography, and the finding that ZnL in acetonitrile forms a monomeric species indicates that acetonitrile is also likely to also coordinate. In these donor solvents, it is likely that ZnL(solvent) will be the dominant solution species. In each of these solvents, the absorption, emission, and excitation spectra were nearly superimposable with that of a dichloromethane solution (Table 2). This shows that the identity of the coordinated base affects neither the absorption nor emission properties to any significant extent.

TABLE 2
Electronic absorption, emission, and
fluorescence quantum yield of ZnL.

| Solvent | λₘₐₓ (Abs.) | λₘₐₓ (em.) | φₑₘ |
|---|---|---|---|
| dichloromethane | 424 nm | 538 nm | 0.30 |
| Toluene | 424 nm | 535 nm | 0.35 |
| Acetonitrile | 422 nm | 538 nm | 0.36 |
| Ethanol | 422 nm | 533 nm | 0.43 |
| Pyridine | 425 nm | 535 nm | 0.55 |
| THF | 422 nm | 531 nm | 0.59 |

Quantum yields for emission (φₑₘ) for the fluorescent excited state were also measured in different solvents, to quantify any changes in the fluorescent excited state due to coordinated solvent or the monomer/dimer equilibration. In each solvent tested, φₑₘ varied only modestly over the range 0.3-0.6, despite the significant variation in solvent properties over this series. It is clear that the fluorescent excited state is not overly sensitive to changes in axial ligand nor to changes in solvent composition.

Cyclic voltammetry of ZnL(EtOH).EtOH (1 mM) in acetonitrile revealed two quasi-reversible redox processes at positive potential. The first oxidation process at E_{1/2}=+0.373 V, ZnL→ZnL++e⁻, is likely localized on the phenolate ring of the salophen ligand. The second oxidation process may be a subsequent oxidation to form the dicationic species ZnL²⁺, however this will not be considered further.

TABLE 3
Electrochemistry of ZnL (1 mM) in acetonitrile.

| E_{c} | Eₐ | ΔE | E_{1/2} |
|---|---|---|---|
| 0.430 | 0.315 | 0.115 | 0.373 |
| 0.633 | 0.538 | 0.095 | 0.586 |

vs. Fc^{0/+}, 0.1M TBA(PF₆)

The excited-state energy (E₀₀) was estimated from the intersection of the absorption and emission spectra at 492 nm, E₀₀=2.52V. The uncertainty in this value is estimated at +/−0.1 eV. The excited state oxidation potential for ZnL* (E(Zn_{L}+/Zn_{L}*)) was estimated from E₀₀ and the ground state oxidation potential (E(Zn_{L}+/Zn_{L})) as −2.1V using eq 2.

E(Zn_{L}+/Zn_{L}*)=E(Zn_{L}+/Zn_{L})−E00=−2.1 V (2)

ZnL* is a strongly reducing excited state, with a driving force sufficient to reduce many nitroaromatics, as well as DMNB. (Measured redox potentials in V (vs.) Fc^{+/0}): 2,3-dimethyl-2,3-dinitrobutane (DMNB), −2.00; nitro-m-xylene (NX), −1.85; nitrotoluene (NT), −1.62; nitrobenzene (NB), −1.57; nitroquinoline (NQ), −1.38.) This suggested that the excited state (ZnL*) would be quenched by such compounds.

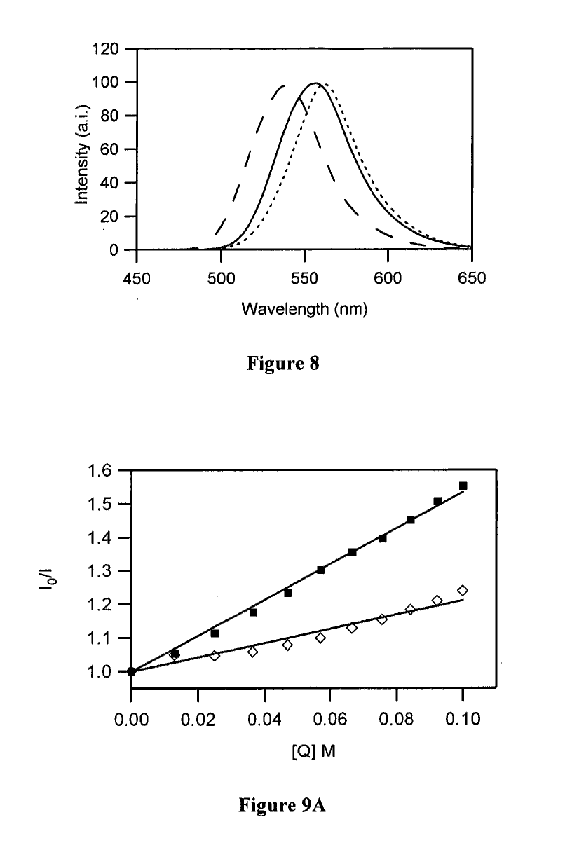

Solid-state effects on fluorescence. The color of the ZnL(base) solids depended on the coordinated base, leading to measurement of solid-state emission spectra (FIG. 8). The maximum emission wavelength increased by 22 nm over the series (py<EtOH<THF). This trend may reflect the donor properties of the base, in which case solution properties would vary depending upon the Lewis basicity of the solvent, or on π-stacking within the lattice. As the emission and absorption spectra for ZnL did not vary in different solvents, it can be concluded that the differences observed in the solid state arise from intermolecular interactions, rather than from the properties of coordinated ligands.

The packing within the solid state for the EtOH and THF structures revealed that salophen ligands adopted parallel planar structures, such that adjacent salophen ligands were π-π stacked at a distance of 3.4 Å. In contrast, the salophen ligands within the py structure were not in registry, adopting canted orientations with closest contacts between salophen ligand and the py ligand from an adjacent molecule. As π-stacking is known to cause red-shifts in emission spectra in other systems, this is likely the origin of the red-shift in emission wavelength for ZnL(THF) and ZnL(EtOH) relative to ZnL(py).

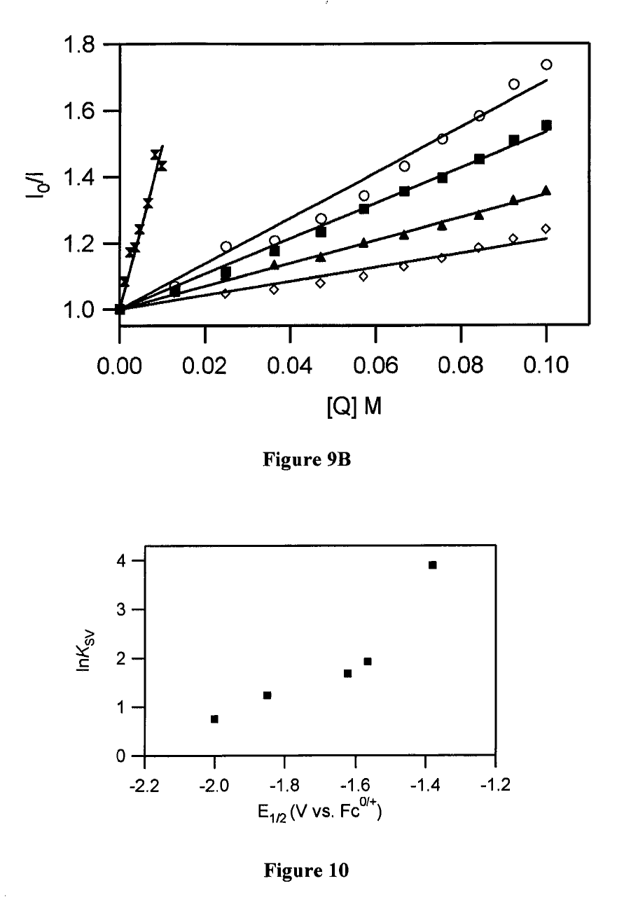

Quenching by Nitroaromatics and DMNB. The strongly reducing nature of ZnL* prompted investigation of fluorescence quenching by DMNB and nitroaromatics in CH₃CN solution. Titrating DMNB, nitro-m-xylene (NX), nitrotoluene (NT), nitrobenzene (NB), and nitroquinoline (NQ) quenched the fluorescence at 538 nm. Analysis of the normalized fluorescence intensity (I₀/I) as a function of increasing quencher concentration ([Q]) was well described by the Stern-Volmer equation, I₀/I=1+K_{SV}[Q], for all titrants. Linear Stern-Volmer behavior is consistent with a dynamic process, in which the titrant collides with ZnL* to quench the fluorescent excited state; the titrations of NT and DMNB are shown as examples in FIGS. 9A-B. NQ exhibits a significantly quenching efficiency than other quenchers, suggesting that it may quench ZnL* by a process that involves binding to the axial position of ZnL. Attempts to quantify NQ binding to ZnL by ¹H-NMR were unsuccessful due to the overlapping chemical shifts of ZnL and nitroquinoline (data not shown); however, the ZnL imine chemical shift changed from 7.979 ppm to 7.757 ppm upon addition of 48 mM NQ, indicating that a weak binding interaction took place.

The Stern-Volmer constants (K_{SV}) reflects the competition between bimolecular quenching and unimolecular fluorescence decay, with K_{SV} indicating the efficiency of quenching relative to the intrinsic fluorescent lifetime. Quenching efficiencies rage from 2.1M⁻¹ for DMNB to 49 for nitroquinoline (Chart 1). As the fluorescence lifetimes of related (salen)Zn are in the range of 1×10⁻⁹ s, and quenching efficiencies are roughly 5 M⁻¹, it is likely that the bimolecular quenching rates are in the range of 5×109 M⁻¹s⁻¹.

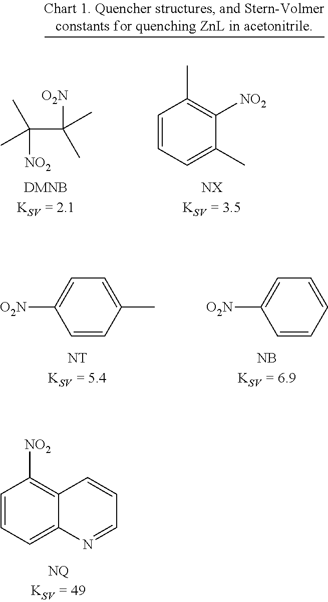

Indirect comparisons of the quenching efficiency of ZnL to the polymeric metalloles, or the amplifying fluorescent polymers (AFPs) of the prior art are possible with the caveat that those polymeric fluorophores are quenched by static mechanisms. Polymeric metalloles with a repeat length of about 10 units are highly efficient quenchers of nitroaromatics, with solution quenching efficiencies up to 1200 M⁻¹ toward nitrobenzene. However, the dominant interaction with nitroaromatics is proposed to be π-stacking with partial charge-transfer, which is not expected to be applicable to DMNB. Indeed, no report of metallole quenching by DMNB has appeared. AFPs are conjugated fluorescent polymers which show similar quenching efficiencies in solution toward nitroaromatics, with a similar reliance on π-stacking. One report of quenching efficiencies for DMNB toward thin-film AFPs are in the range of K_{SV}=3-20 M⁻¹, which are up to ten-fold higher than the solution-phase (CH₃CN) quenching efficiency of DMNB toward ZnL.

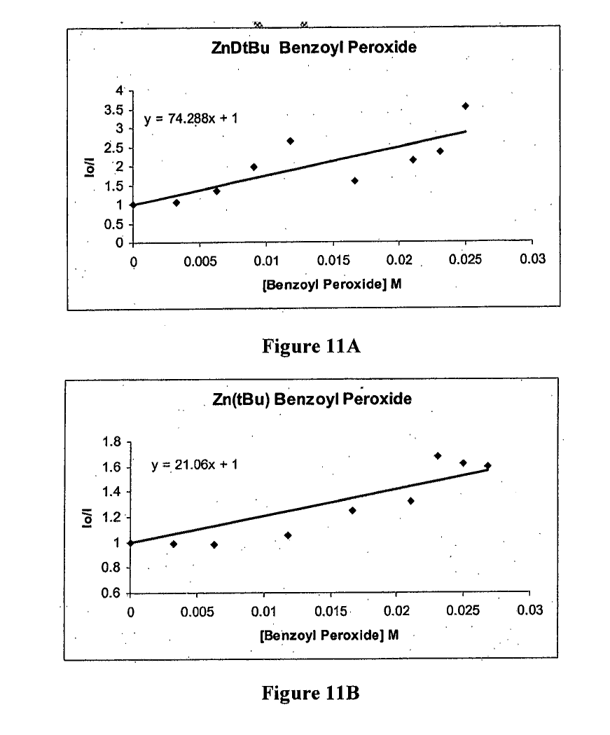

Without limitation to any one theory or mode of operation, described here or elsewhere herein, a proposed quenching reaction is ZnL*+RNO₂→ZnL++RNO₂₋, in which the nitro-compound accepts an electron from the excited state of ZnL. (Reference is made to the illustration of Scheme 2.) The driving force (ΔG) for this photoinduced electron transfer reaction is favorable, based upon the redox potentials (ΔG=−nF(E(RNO₂/RNO₂.)−E(Zn_{L}*/Zn_{L}+)). In support of this electron-transfer mechanism is the linear relationship between lnK_{SV} and E_{1/2} (FIG. 10) for all quenchers except NQ.

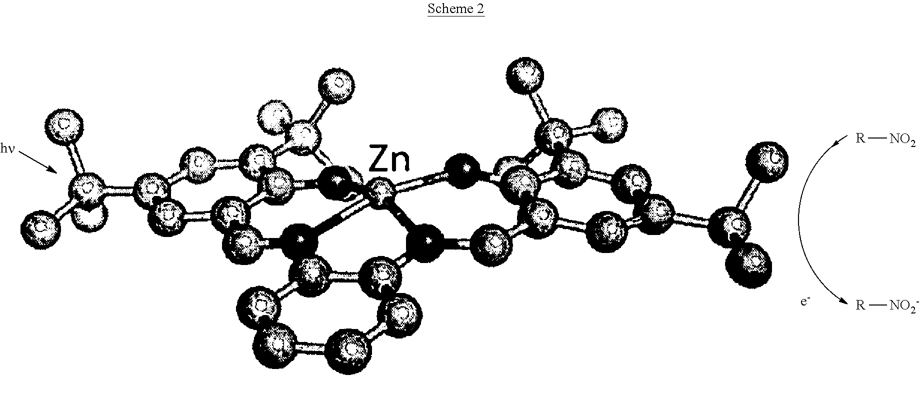

As discussed above, the complexes of this invention can also be used as fluorescence sensors for peroxides, such as TATP. With further reference to Scheme 2, electron-poor peroxides (R—O—O—R), quench the fluorescence (accept an electron from the excited state of such a complex), whether such a peroxide/explosive is in the solution or solid phase by solid sampling methods. Illustrating the use of this invention to detect peroxides, fluorescence was quenched by benzoyl peroxide, a structural mimic of TATP and other such peroxide explosives. (See, FIGS. 11A-B.)

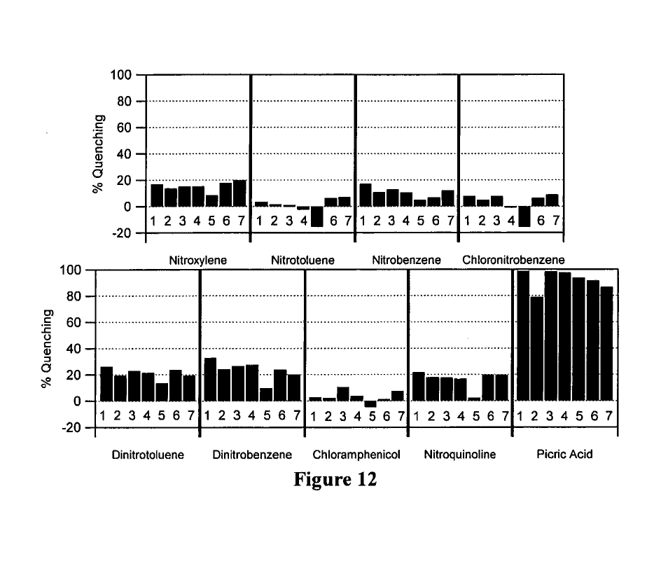

As mentioned above, the present invention can also be employed in the context of a sensor array and related apparatus components. With non-limiting reference to examples 3a-b, a group of representative fluorophores was excited at 400 nm and emission was measured at 520 nm, in the presence of a group of nitro compound analytes. (As would be understood by those skilled in the art made aware of this invention, such an array can be used to detect peroxides or a combination of peroxide and nitro compounds.) The emission intensity was normalized to correct for variation in ZnL^{R} emission over small concentration ranges by using percent quenching values. These percent values were calculated by using the initial ZnL^{R} intensity in conjunction with quenched fluorescence intensity values as described, ((Iₒ/I)/I₀)×100=% Quenching. The 7-D fingerprint for each nitro containing analyte demonstrates the varied response for each ZnL^{R} complex. (FIG. 12.) A combination of structural and physical properties of the analytes led to the discriminatory responses. The quenching efficiency will typically be enhanced by a more oxidizing nitro compound, as the photoinduced electron transfer will be more favorable.

ZnL^{R}+Q+hν→ZnL^{R}*+Q→(ZnL^{R})⁺+Q⁻

The 3-D structure and the steric bulk of both the ZnL^{R} and the quencher affects the deactivation pathway, be it collisional or static, and thus impacts the quenching efficiency. Lastly, a quencher containing a strong Lewis base will tend to coordinate to the Zn molecule in a concentration dependent equilibrium process, which enhances quenching.

To determine the ability of the array to discriminate and classify unknown samples, the data was analyzed with Classical LDA statistics. The 7 ZnL×9 quenchers×9 replicates data matrix was entered into SYSTAT and discriminant functions were determined. The percent quenched values were utilized in this analysis to correct for intensity changes due to concentration differences between plates and stock solutions, as well as instrumentation variation. The discriminant function values are chosen to maximize differences between groups for classification. Each variable calculated is weighted according to its ability to discriminate among the defined groups.

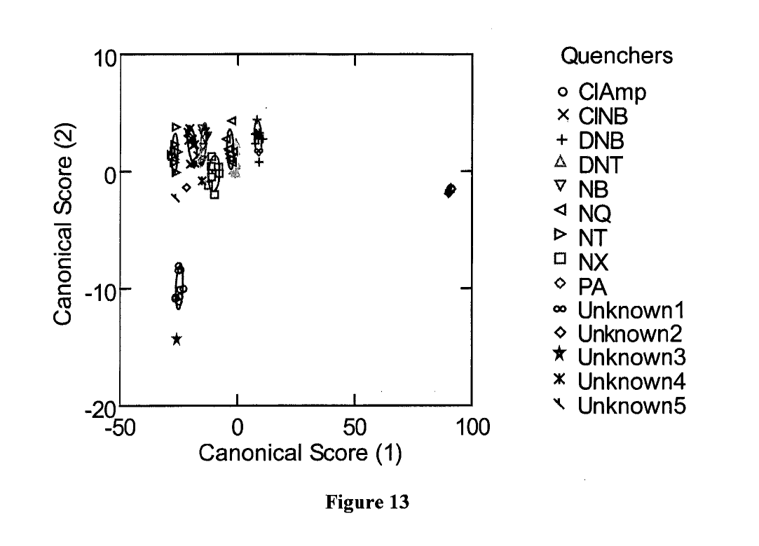

Overall relationships between groups were determined to assess the multi-dimensional group variance factors. Mahalanobis distances are the measured distances in multi-dimensional space from a measurement to the nearest classification group. The program uses these distances (Table 4) to definitively describe each unknown analyte in terms of the priori trained analytes as the closest group in space. (FIG. 13.) This analysis determines the correlation between two sets of variables by generating a linear combination of the original variables along with canonical coefficients that weight the importance of a variable on differentiation. A canonical score plot was generated in which the score is the numerical value assigned to a variable, for each case, based upon canonical coefficients, or factors. These plots indicate where each variable is located in 2-dimensional space, so that an unknown sample can be classified as a particular group based upon its distance to all of the canonical groups. The distance analysis identified 5 quenchers out of the 5 unknowns correctly, considering small deviations in data collection.

TABLE 4
2-D Mahalanobis distances for all known quenchers
and unknown samples for classification matrix.

| | Mahalanobis | Mahalanobis |
|---|---|---|
| Quencher | Distance 1 | Distance 2 |
| Chloramphenicol | 6.5 | 194.4 |
| Chloronitrobenzene | 195.4 | 12.5 |
| Dinitrobenzene | 1252.6 | 795.8 |
| Dinitrotoluene | 675.8 | 372.4 |
| Nitrobenzene | 263.9 | 55.1 |
| Nitroquinoline | 611.8 | 291.6 |
| Nitrotoluene | 148.7 | 72.8 |
| Nitroxylene | 336.8 | 146.3 |
| Picric Acid | 13345.2 | 12113.5 |
| Unknown 1 (DNB) | 1476.0 | 1005.6 |
| Unknown 2 (ClNB) | 135.7 | 21.0 |
| Unknown 3 (ClAmp) | 42.1 | 314.0 |
| Unknown 4 (NB) | 260.5 | 94.5 |
| Unknown 5 (NT) | 72.12 | 43.0 |

Quencher samples normalized, A₃₀₀ = 1.

### EXAMPLES OF THE INVENTION

The following non-limiting examples and data illustrate the various aspects and features relating to the methods and/or systems of the present invention, including the use of one or more Zn(salen) complexes for the discrimination and detection of various nitro or organic peroxide compounds, as described herein. In comparison with the prior art, the present methods, systems and complexes provide results and data which are surprising, unexpected and contrary thereto. While the utility of this invention is illustrated through the use of several methods/systems and Zn(salen) complexes which can be used therewith, it will be understood by those skilled in the art that comparable results are obtainable with various other methods/systems and Zn complexes, to detect various other organic and non-organic nitro and/or peroxide compounds, as are commensurate with the scope of this invention.

All chemicals were purchased from Aldrich and Fisher Scientific, and used as received unless specified. Solvents were purchased from VWR scientific, and dried and distilled from CaH₂ (MeCN), Mg (EtOH), Na (Toluene), Na benzophenone (THF), CaH₂ (CH₂Cl₂). Phenylenediamine was recrystallized from water, and stored in an inert atmosphere glovebox until use. NMR solvents were purchased from Cambridge Isotope Laboratories, and used as received. Elemental analyses (C, H, N) were performed at the University of Massachusetts microanalysis laboratory.

With reference to examples 1a-e, and unless otherwise indicated, L is a di-tert-butyl salen ligand, a structure of which (1) is shown in Chart 2, below. The characterization data of examples 1b-c is consistent with that available for the ligands/complexes of examples 1d-g.

### Example 1a

ZnL(base). To a flask of dry ethanol, ortho-phenylenediamine (0.5 mmol) and 3,5-di-tert-butyl salicylaldehyde (1 mmol) were added and refluxed overnight. The reaction mixture was filtered and a yellow solid, H₂L (H₂L=N,N′-phenylenebis-(3,5-di-tert-butylsalicylideneimine) was collected. H₂L (0.5 mmol), was dissolved in ethanol with heat and a solution of Zn(OAc)₂ (0.5 mmol) in ethanol was added dropwise. The orange solution was refluxed for 2 hours and cooled to room temperature. Bright orange crystals of ZnL(EtOH).EtOH were collected and analyzed. Elemental analysis for C₄₀H₅₇N₂O₄Zn calculated (found): C, 69.10 (69.02); H, 8.28 (8.44); N, 4.03 (3.96). ¹H-NMR (CD₂Cl₂): δ 8.32 (bs, 2H imine), δ 7.37 (d 2H aromatic), δ 7.28 (bs 4H aromatic), δ 6.77 (bs 2H aromatic), δ 3.63 (q 4H CH₂ ethanol), δ 1.40 (bs, 18H t-butyl), δ 1.27 (s, 18H, t-butyl), δ 1.17 (t, 6H, CH₃ ethanol). b, broad; d, doublet; s, singlet; q, quartet. Recrystallization of ZnL(EtOH).(EtOH) from the respective solvents yielded yellow crystals of ZnL(py) or orange crystals of ZnL(THF).

### Example 1b

X-ray crystallography. Data were collected on a Bruker-Nonius KappaCCD diffractometer utilizing Mo Kₐ radiation. Epoxy was used to mount crystals on a thin glass fiber, which were cooled to ˜125K in the cold stream produced of an Oxford Cryosystems cooler. Scans were designed using the Bruker-Nonius Collect package, while integration and scaling were done using the routines HKL2000 and Scalepak. Structure solutions were obtained using the SIR software, providing atomic coordinates for a refinement using SHELXL-97, utilizing the interface and the additional utilities of WinGX. In ZnL(THF) and ZnL(py), the data quality allowed hydrogens to be located from the difference map and freely refined with isotropic thermal parameters. This was not the case for ZnL(EtOH).EtOH, where hydrogens could only be reasonably refined by constraining them to ideal geometries and performing a riding refinement with hydrogen thermal parameters fixed at a multiple of their bounded partner. Structures were validated using the functionality of PLATON. Crystallographic data is summarized in Table 1.

TABLE 1
Crystallographic Data for ZnL(EtOH)•EtOH, ZnL(THF), and ZnL(py).

| | ZnL(EtOH)•EtOH | ZnL(THF) | ZnL(py) |
|---|---|---|---|
| Empirical formula | C₄₀H₅₈N₂O₄Zn | C₄₀H₅₄N₂O₃Zn | C₄₁H₅₁N₃O₂Zn |
| M (g mol−1) | 696.25 | 676.22 | 683.22 |
| Crystal system | monoclinic | triclinic | orthorhombic |
| Space group | P2₁/c (#14) | P-1 (#2) | P b c m (#57) |
| a (Å) | 13.1292(3) | 10.9600(4) | 15.4018(2) |
| b (Å) | 24.9288(5) | 13.0670(5) | 10.4556(1) |
| c (Å) | 11.6353(2) | 13.1540(5) | 23.1113(3) |
| α (°) | 90 | 91.943(2) | 90 |
| β (°) | 91.4833(8) | 104.094(2) | 90 |
| γ (°) | 90 | 92.054(2) | 90 |
| V (Å³) | 3806.9(1) | 1824.2(1) | 3721.73(9) |
| Z | 4 | 2 | 4 |
| Temperature (K) | 125 | 120 | 120 |
| ρcalc (g/cm3) | 1.215 | 1.231 | 1.219 |
| μ(Mo K_{α}) (mm−1) | 0.7107 | 0.7107 | 0.7107 |
| F(000) | 1496 | 724 | 1456 |
| θ range (°) | 3.7-27.5 | 3.7-25.7 | 1-27.5 |
| Reflns collected | 16596 | 11682 | 8092 |
| Indep reflns | 8682 | 6863 | 4354 |
| Obsd reflns [I > 2σ] | 5432 | 5667 | 3685 |
| Rint | 0.0622 | 0.0413 | 0.0197 |
| Parameters refined | 442 | 615 | 331 |
| R₁ (all, >4σ) | 0.1014, 0.0477 | 0.0575, 0.425 | 0.0429, 0.0327 |
| wR₂ (all, >4σ) | 0.1168, 0.1018 | 0.1067, 0.096 | 0.0859, 0.0799 |
| χ² | 1.020 | 1.054 | 1.046 |
| Δρ(min, max, avg) | 0.60, −0.38, 0.07 | 0.75, −0.80, 0.06 | 0.39, −0.49, 0.05 |
| (e/Å3) | | | |

### Example 1c

Physical Characterization. Electrochemical measurements were performed on a BAS CV50W cyclic voltammeter using Fc/Fc⁺ as an internal standard, 0.1M tetrabutylammonium hexafluorophosphate as a supporting electrolyte, a Pt working electrode, a Pt auxiliary electrode, and Ag/AgCl as a reference electrode. ¹H-NMR spectra were collected with a Bruker 400 MHz (400.13 MHz) spectrometer. Solution molecular weight determinations were measured by vapor pressure osmometry using a Wespro Vapro model 5520 calibrated with benzil.

NMR titration spectra were collected in CD₂Cl₂ (EtOH) or CD₃CN (Nitroquinoline). The titrations were monitored by chemical shift changes of the imine peak (˜8.3 ppm). Titration of ethanol was performed at a 12 mM ZnL concentration with EtOH added via micropipet. Titration of nitroquinoline was performed in the same manner with a ZnL concentration of 8 mM; due to spectral overlap in the aromatic region, the nitroquinoline titration was not taken to completion.

Absorbance measurements were collected in a quartz cuvette with a 1 cm path length on a Hewlett Packard 8453 UV-Vis spectrophotometer. Quantum yield measurements were performed in a quartz, 1 cm path length cuvette, on a JASCO FP-6500 spectrofluorometer in acetonitrile, ethanol, pyridine, tetrahydrofuran, and toluene. Quinine sulfate in 0.1M H₂SO₄, used as a standard (φ=0.54), was excited at 400 nm and the emission monitored at 450 nm. Solutions of ZnL were also excited at 400 nm and monitored at λₑₘ=530-540 nm. The resulting fluorescence intensities were plotted against solution absorbances to generate a linear plot to calculate the quantum yield of ZnL in different solvent environments.

### Example 1d

With reference to the synthetic procedure of example 1a, various other salen ligands and Zn complexes can be prepared, limited only by choice and availability of a corresponding salicylaldehyde and diamine starting materials. Representative L^{R} ligands and Zn complexes are as shown in Chart 2.

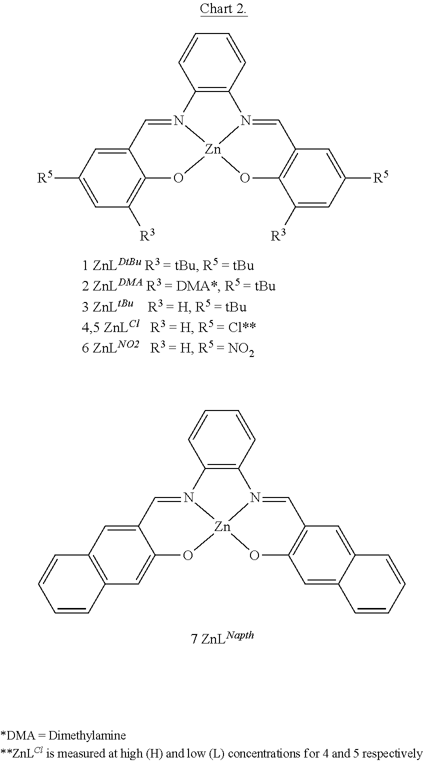

### Example 1e

5-tert-Butyl-2-hydroxy-3-(dimethylamino-methyl) benzaldehyde A Mannich reaction was utilized to form substituted salicylaldehyde as reported. (JACS124,12668,2002) To a flask of 0.5 ml EtOH was added 5-t-butyl-2-hydroxybenzaldehyde (1.12 mmol). Formaldehyde (1.68 mmol) was suspended in EtOH/water (50/50 v/v %) and added to flask, the resultant solution was stirred and heated for 15 minutes. Finally dimethylamine (40% in water) (1.68 mmol) was added. The yellow solution refluxed overnight, solvent was evaporated in vacuo, taken up in DCM and dried over Na₂SO₄. The yellow oil was purified by chromatography on SiO₂, (1:3 EtOAc/Hex) and yielded a yellow solid, 76%. ¹H NMR (400 MHz, DCM): δ 11.69 (br s, 1H), 10.35 (s, 1H), 7.62 (d, 1H), 7.33 (d, 1H), 3.68 (s, 2H), 2.34 (s, 6H), 1.30 (s, 9H).

### Example 1f

ZnL^{DMA}(H₂L^{DMA}=N,N′-phenylenebis-(5-tert-butyl-4-dimethylamine-salicylideneimine)) Dry EtOH, ortho-phenylenediamine (0.5 mmol), and Zn(OAc)₂ (0.5 mmol) were added to a flask and stirred at 80° C. for 20 minutes. The substituted salicylaldehyde (1 mmol) was dissolved in a minimum amount of EtOH at 80° C., and the solution was added to the flask. The resulting solution was refluxed for 1 hour and cooled. The precipitate was collected by vacuum filtration, and recrystallized. ¹H NMR (400 MHz, DMSO): δ 9.18 (s, 1H), 7.90 (dd, 1H), 7.63 (d, 1H), 7.58 (d, 1H), 7.43 (dd, 2H), 4.30 (s, 2H), 2.83 (s, 61-1), 1.31 (s, 9H).

### Example 1g

ZnL^{Napth}(H₂L^{Napth}=N,N′-phenylenebis-(napthylsalicylideneimine)) To a flask of dry EtOH, ortho-phenylenediamine (0.5 mmol) and 2-hydroxy-1-naphthaldehyde (1 mmol) were added and refluxed overnight. The reaction mixture was filtered and a yellow solid, H₂L^{Napth} was collected. H₂L^{Napth} (0.5 mmol), was dissolved in EtOH with heat and a solution of Zn(OAc)₂ (0.5 mmol) in EtOH was added dropwise. The solution was refluxed for 2 hours and cooled to room temperature. This compound was isolated as a yellow solid. ¹H NMR (400 MHz, DMSO): δ 9.85 (s, 1H), 8.48 (d, 1H, J=8.8 Hz), 8.17 (dd, 1H, J=3.6, 6.0 Hz), 7.84 (d, 1H, J=9.6 Hz), 7.74 (d, 1H, J=7.6 Hz), 7.51 (t, 1H, J=7.2 Hz), 7.42 (dd, 1H, J=3.6, 6.4 Hz), 7.27 (t, 1H, J=7.2 Hz), 7.03 (d, 1H, J=9.2 Hz). Anal Calcd for C₂₈H₁₈N₂O₂Zn.2H₂O: C, 65.19; H, 4.30; N, 5.43. Found: C, 65.50; H, 4.04; N, 5.30.

### Example 2a

With reference to FIGS. 11A-B, the data show that benzoyl peroxide quenches the fluorescence intensity of two Zn(salicylaldimine) complexes. The experiments were performed by creating a solution of benzoyl peroxide in acetonitrile (0.1M) and a solution of the Zn(salicylaldimine) complex also in acetonitrile (˜40 μM). A cuvette is filled with the Zn(salicylaldimine) solution and a fluorescence spectrum is collected. The solution of peroxide is added in small volume increments via micropipette, and with each additional spectrum is recorded. A photoinduced electron transfer occurs between the Zn(salicylaldimine) donor and peroxide acceptor, resulting in a decrease in fluorescence intensity as shown in the respective Stern Volmer plots.

A Stern Volmer quenching analysis indicates the presence of peroxides with the quenching efficiency (K_{SV}) extrapolated from the slope of the best fit line. The plots above show high quenching efficiencies for the Zn(salicylaldimine) ZnDtBu and ZntBu, K_{SV}=74 and 21 respectively.

With reference to the sensor array embodiment(s) illustrated in the following examples, absorption measurements were collected on a Hewlett Packard 8453 UV-Vis spectrophotometer in a quartz cuvette. Fluorescence spectra were collected on a JASCO FP-6500 spectrofluorometer in a quartz cuvette. The ZnL^{R} complexes were dissolved in dry acetonitrile with the exception of ZnL^{NO2}, ZnL^{Cl}, and ZnL^{Napth}, which also required trace amounts of DMSO for solubility.

### Example 2b

A methodology of the sort illustrated in the preceding example can be used to detect the presence of and/or identify various other organic and non-organic nitro and/or peroxide compounds associated with chemical explosive materials. Without limitation, this invention is used to detect/identify organic nitro compounds, such as nitroaromatics, including but not limited to trinitrotoluene and organic nitroalkanes, including but not limited to 2,3-dimethyl-2,3-dinitrobutane and organic peroxide compounds, including but not limited to triacetone triperoxide (TATP); and organic nitroamine compounds, including but not limited to cycloteteramethylene-tetranitramine (HMX), and cyclotrimethylenetrinitramine (RDX). Likewise without limitation, this invention is used to detect/identify various inorganic and nitro and peroxide compounds, the latter including but not limited to hydrogen peroxide.

### Example 3a

The complex samples for quenching were measured in 96 well polypropylene plates on a Molecular Devices SpectraMax M5 microplate reader with 400 nm excitation and 520 nm emission. Representative of various other embodiments of this invention (e.g., peroxide analytes and related sensor systems) quenching experiments were performed. Equal volumes of nitro quencher (in CH₃CN) and ZnL^{R} were added to each well, dried and the fluorescence intensity (I) measured. Two different experiments were performed, the first in which the stock concentration of quencher was known (0.4M); for the second, stock quencher solutions were normalized such that A₃₀₀=1. (See, FIG. 13.)

### Example 3b

Three separate plates were analyzed with 3 readings collected for each plate for a training data matrix of 7 ZnL^{R} complexes×9 quenchers×9 replicates. The percent quenching was calculated by using ((Iₒ−I)/I₀)×100=% Quenching where I₀ is the fluorescence intensity without added quencher solution. The raw data was analyzed using a processor loaded with a Classical Linear Discriminant Analysis (LDA) in SYSTAT (version 11.0) software package. All variables were used with a tolerance level set to 0.001. The canonical factors or scores as well as Mahalanobis distances of each pattern to the centroid (99%) of each group in space were assessed. The analyte classifications were based upon the shortest distance to the respective group. The distances (Table 4) were used to describe an unknown analyte in terms of the privri trained analytes. (See, FIG. 13.) Such results demonstrate use of this invention to detect and identify an unknown peroxide or nitro analyte compound, whether peroxide or nitro.

### Example 3c

A methodology of the sort illustrated in the preceding example can be used to detect the presence of and/or identify various other organic and non-organic nitro and/or peroxide compounds associated with chemical explosive materials. Without limitation, this invention is used to detect/identify organic nitro compounds, such as nitroaromatics, including but not limited to trinitrotoluene and organic nitroalkanes, including but not limited to 2,3-dimethyl-2,3-dinitrobutane and organic peroxide compounds, including but not limited to triacetone triperoxide (TATP); and organic nitroamine compounds, including but not limited to cycloteteramethylene-tetranitramine (HMX), and cyclotrimethylenetrinitramine (RDX). Likewise without limitation, this invention is used to detect/identify various inorganic and nitro and peroxide compounds, the latter including but not limited to hydrogen peroxide.

As demonstrated above, the fluorescence of ZnL^{R} can be quenched by nitro and peroxide compounds with Stern-Volmer constants of K_{SV}˜2-˜49 M⁻¹. Representative of various other embodiments, the Zn salophen complexes illustrate improved DMNB sensors. ZnL^{R} can form a dimeric structure in solution which converts to a monomeric structure by binding Lewis bases, as shown by ¹H-NMR and solution molecular weight measurements. The fluorescence quantum yield in solution is nearly insensitive to axial ligand identity or dimerization. The emission spectra of ZnL^{R}(base) in the solid-state varies due to π-stacking interactions, evidencing that the fluorescence properties of ZnL^{R} can be tunable in the solid state by environmental perturbations.

We claim:

1. A method of detecting the presence of a chemical explosive material, said method comprising:
providing an irradiated chemical system comprising a zinc metal center and a salen ligand, said system fluorescent;
contacting said system with a subject analyte; and
detecting the presence of a chemical explosive material, said material comprising a compound selected from peroxide compounds, nitro compounds and combinations of said compounds, said presence indicated by a change in at least one of the time and intensity of said system fluorescence.

2. The method of claim 1 wherein said analyte comprises a compound selected from explosive organic peroxide compounds and combinations thereof.

3. The method of claim 1 wherein said analyte comprises a compound selected from organic nitro compounds and combinations thereof, said compound selected from explosive organic nitro compounds and organic nitro taggant compounds.

4. The method of claim 1 wherein said system comprises a salophen ligand.

5. The method of claim 1 wherein structural variation of said salen ligand affects said fluorescence.

6. The method of claim 5 wherein said analyte compound quenches said fluorescence.

7. The method of claim 5 comprising a plurality of Zn(salen) complexes, each said complex providing a change in fluorescence responsive to a said analyte compound.

8. The method of claim 1 wherein said system is incorporated into an apparatus comprising a solid substrate.

9. The method of claim 1 comprising providing reference spectral data comprising change in fluorescence for interaction of a Zn(salen) complex with a plurality of said analyte compounds; comparing said reference data with change in fluorescence upon contact of said complex with a said compound; and identifying said compound.

10. The method of claim 9 wherein said reference spectral data comprises fluorescence changes of a plurality of said complexes with a plurality of reference compounds.

11. The method of claim 10 wherein structural variation of said salen ligands affects said reference fluorescence data.

12. The method of claim 9 wherein said comparison is selected from direct spectral comparison and a discriminant analysis technique, for said compound identification.

13. A method of identifying a chemical explosive-related material, said method comprising:
contacting at least one irradiated fluorescent Zn(salen) complex with at least one analyte compound providing reference spectral data comprising change in fluorescence for contact of said Zn(salen) complex with a plurality of reference organic nitro compounds and reference organic peroxide compounds;
comparing spectral data for said contacted complex with said reference spectral data; and
identifying said contacted analyte compound indicated by said comparison.

14. The method of claim 13 wherein said reference spectral data comprises fluorescence changes of a plurality of said complexes with a plurality of said reference compound, and at least one said analyte compound contacted with a plurality of said complexes, said contact providing a pattern of fluorescence changes for each said contacted analyte compound, said pattern identifying said contacted analyte compound.

15. The method of claim 14 wherein structural variation of said salen ligands affects said reference fluorescence data.

16. The method of claim 13 wherein said comparison is selected from direct spectral comparison and a discriminant analysis technique, for said analyte compound identification.

17. The method of claim 13 wherein said complex is incorporated into an apparatus comprising a solid substrate.

18. A method of using Zn(salen) fluorescence to detect the presence of an organic nitro compound or an organic peroxide compound, said method comprising:
providing a Zn(salen) complex;
irradiating said complex for at least one of a time and at a wavelength at least partially sufficient for fluorescence of said complex;
contacting said complex with a compound selected from organic nitro compounds, organic peroxide compounds and a combination of said compounds, at least one of said contact and the amount of said compound at least partially sufficient to change at least one of the time and intensity of said fluorescence; and
monitoring said fluorescence change.

19. The method of claim 18 wherein said complex comprises a salophen ligand, said ligand structure varied to affect said fluorescence.

20. The method of claim 18 wherein said compound quenches said fluorescence.

21. A sensor apparatus for detecting the presence of an organic compound associated with a chemical explosive material, said apparatus comprising a spectrophotometer and a solid substrate component comprising a Zn(salen) complex thereon, said substrate component positioned within said spectrophotometer for irradiation thereof.

22. The apparatus of claim 21 comprising a solid matrix comprising an array of a plurality of Zn(salen) complexes.

23. The apparatus of claim 22 comprising a processor for discriminant analysis, said processor coupled to said spectrophotometer.
